(19) United States
(12) Patent Application Publication
(10) Pub. No.: US 2014/0154004 A1
(43) Pub. Date: Jun. 5, 2014

(54) Connector

(71) Applicant: Aber Instruments Ltd, Aberystwyth (GB)

(72) Inventor: Lindsay Agate, Ceredigion (GB)

(73) Assignee: Aber Instruments Ltd, Aberystwyth (GB)

(21) Appl. No.: 14/088,354

(22) Filed: Nov. 23, 2013

(30) Foreign Application Priority Data
Nov. 30, 2012 (GB) 1221576.0

(51) Int. Cl. F16B 21/04

(52) U.S. Cl. CPC F16B 21/04
USPC 403/349

(57) ABSTRACT

A connector to enable connection between a device that is typically poorly supported meaning that when the connector is brought into contact with the device there can be little force applied to the device in order that it does not move. A device may be a flexible disposable bioreactor wherein a probe is secured within the bioreactor and a connection enables a reading to be taken from the electrodes of the probe. The connector includes a device connection arrangement, a collar rotatable between a first configuration enabling releasable engagement with a device and a second configuration wherein the device is restrained by the collar. A shoulder is provided in the device connection arrangement to limit insertion of at least a portion of the device into the recess wherein the shoulder aligns at least a portion of the device with a channel provided in the radially inwardly surface of the collar.

### CROSS-REFERENCE TO RELATED APPLICATIONS

This application claims the benefit under 35 U.S.C. §119(a)-(d) and (f) of GB 1221576.0, filed 30 Nov. 2012, the entire contents and substance of which is hereby incorporated by reference.

### BACKGROUND OF THE INVENTION

1. Field of Invention

The present invention relates to a connector that beneficially enables connection between a device that is typically poorly supported, meaning that when the connector is brought into contact with the device there can be little force applied to the device in order that it does not move. An example of such a device is a flexible disposable bioreactor wherein a probe is secured within a wall of the bioreactor and a connection is required to enable a reading to be taken from the electrodes of the probe.

2. Background and Related Art

Single use or disposable biomass monitoring apparatus are presently utilized which comprise an enclosure provided for containing a biological medium and a probe or sensing device for making an impedance measurement of the medium. Accordingly, a sensing device or probe is fixed through a wall of the enclosure in such a way to form a seal and ensure there is no leakage. The enclosure itself can be a flexible polymeric material meaning that the enclosure itself does not form a rigid structure. This can be effectively visualized as a flexible plastic bag. This results in a problem when the enclosure is positioned for use a connector must be connected to the sensing device in order for the capacitance measurement to be transferred from the electrode of the sensing device to the monitoring device. Accordingly, the connector must be fixed to the sensing device. However, when a force is applied to the sensing device and thus the enclosure the flexible nature of the enclosure means that it is difficult to secure a connector to the necessary measurement device.

FIG. 1 shows a schematic representation of an arrangement devised by the applicant to overcome the above mentioned problem. Referring to FIG. 1, the connector 1 connects to a sensing device 2. On the underside of this sensing device 2 four electric probes are provided which in extend into the enclosure for receiving electrical information in order that capacitance can be calculated from a biological medium. This sensing device is secured in the wall of a flexible enclosure typically via an adhesive and thus forms a part of the wall of the enclosure and ensures that there is no leakage of the biological material from the enclosure. In the arrangement shown the sensing device comprises a plate like disk 4 to be secured to and in the surface of the enclosure. Four probes are provided on a molded projection extending outwardly from the plane of the underside of the sensing device. Shown in FIG. 1 is the rearward portion of the sensing device. Visible in FIG. 1 is a sensing device ear 6 protruding in the longitudinal axis of the sensing device secured to a support 8. Diametrically opposing sensing device ears 6 are provided substantially on opposite sides of the support 8. The ears include a lateral protrusion 10. Between the ears 6 sit (not visible in FIG. 1) four connections extending from the electrodes which extend into the enclosure. These electrodes extend through the connector and a signal is taken from the electrodes to a monitoring device where capacitance of the medium under measurement is determined.

Referring now to the connector 1 with reference also to FIGS. 2 and 3, the connector comprises a body 12 which provides an aperture (not shown) into which an interface arrangement 14 seats. In FIG. 1, the interface arrangement is hidden behind the collar 16 and a further part is hidden within the body 12. Referring to FIGS. 2 and 3, the interface arrangement 14 comprises a rearward section 18 which seats into an opening provided in the body 12. Opposing sides of the rearward section 18 indicated by reference numeral 20 are chamfered and are received by a corresponding shaped opening in the body 12. This rearward section 18 is therefore received into the body 12 and is fixedly secured therein via friction joint.

During assembly, the interface arrangement 14 seats into the collar 16 and the rearward section 18 is then secured to the body 12. In this manner the collar 16 is effectively retained between the interface arrangement 14 and the body 12. The collar may, however, rotate relative to the body 12 and the interface arrangement 14. The collar 16 comprises a recess 22 best seen in FIGS. 2 and 3 which is provided cut away from the radially inward surface of the collar. As clearly visible in FIGS. 2 and 3, this recess 22 in the collar 16 provides an opening for receipt of the diametrically opposing lateral protrusions 10 of the sensing device, and the interface arrangement 14 including a cutaway portion 42 defines a space for receipt of the ear 6. During assembly the recess 22 also receives an ear 24 projecting radially outwardly from the interface arrangement 14. As the interface arrangement 14 is received into the collar 16 the ear 24 seats into the recess 22 of the collar 16 and butts up against the ledge or shoulder defining the base of the recess. In communication with the recess 22 is a first channel 26 meaning that as the collar 16 is rotated relative to the interface arrangement 14 and body 12, the ear 24 of the interface arrangement is effectively guided by the channel 26. This can be shown by comparing FIG. 2 and FIG. 3 where in FIG. 2 the ear 24 is shown provided in the recess 22. However, when a collar 16 is rotated as shown in FIG. 3, the collar 16 is moved relative to the ear 24 along the first channel 26. It is important to note that it is the collar 16 that is rotating whereas the interface arrangement 14 remains stationary. The provision of the ear 24 moving through the first channel 26 ensures the accurate maintaining of the axial position of the collar 16 relative to the interface arrangement 14.

It is further noted that the collar 16 comprises a user operable handle 28 enabling ease of use for a user to rotate the collar between a first configuration enabling releasable engagement with a sensing device and a second configuration wherein a sensing device is restrained by the collar shown in FIG. 3.

Further provided in communication with the recess 22 provided in the collar 16 is a second channel 30. The second channel 30 is provided in the radially inwardly surface of the collar 16 and generally extends circumferentially around the inner surface of the collar 16. A portion of the second channel 30 identified by reference numeral 32 extends generally parallel to the first channel 26. A second portion 34 of the second channel 30 extends from the recess 22 not perpendicular to the longitudinal axis of the collar. This configuration is provided such that as the lateral protrusion 10 of the sensing device projecting radially outwardly is located into the recess 22 of the collar 16 and the collar 16 is rotated, the lateral protrusion 10 is drawn along the second portion 34 of the second channel 30 and the angle provided in the second portion 34 of the second channel 30 means that the sensing device is drawn into closer communication with the interface arrangement 14.

FIG. 2 shows a first configuration which enables releasable engagement of the sensing device with the interface arrangement 14. The collar 16 and in particular the handle 28 is rotated in a clockwise direction which then causes second channel 30 to be drawn along the lateral protrusion 10 thus moving to the second configuration whereby the sensing device is restrained by the collar 16. In such a configuration the sensing device cannot be withdrawn from the interface arrangement 14 due to the lateral protrusion 10 and second lateral protrusion 10 provided diametrically opposite which are restrained and effectively retained in the second channel 30. The sensing device is then secured to the connector 1 meaning that information from the enclosure from the electrodes through to connector 1 can be achieved.

In operation, however, there are deficiencies associated with this known arrangement. In use the aim is to ensure that the connector 1 can be positioned in communication with the sensing device whilst transferring minimal pressure onto the sensing device and it is desirable that connection can be achieved with minimal effort. The present invention overcomes the deficiencies associated with this known arrangement.

### BRIEF SUMMARY OF THE INVENTION

Briefly described, in a preferred form, the present invention is a connector for providing connection to a device that is moveable when a force is applied thereto, the connector comprising a device connection arrangement, a collar coaxially and rotatably mounted to the device connection arrangement, wherein the collar is arranged to rotate between a first configuration enabling releasable engagement with a device, and a second configuration wherein the device is restrained by the collar, the collar having a radial thickness defined between a radially outer surface and a radially inner surface, the device connection arrangement including an ear extending radially outwardly, the ear arranged to locate into a recess provided in the radially inwardly surface of the collar, the collar further including a channel extending circumferentially in the radially inwardly surface, the channel being in communication with the recess and being arranged such that as the collar rotates relative to the device connection arrangement between the first and second configuration the channel receives the ear, and further wherein the recess includes a shoulder configured to limit insertion of at least a portion of the device therein, wherein the shoulder substantially aligns at least a portion of the device with a second channel provided in the radially inwardly surface of the collar, and rotation of the collar between the first and second configurations enables the second channel to receive a portion of the device.

An effective solution has been provided to the significant problem of the difficulty when attempting to rotate the collar 16 to secure the ears of a sensing device into the second channel 30. This has been achieved through the provision of the shoulder configured to limit insertion of at least a portion of in particular the ear of the sensing device. This shoulder substantially causes alignment of at least a portion of an ear of a sensing device with the second channel ensuring positive initial engagement of the connector 1 with the sensing device and then enables ease of rotation of the collar 16 to secure the sensing device relative to the connector 1.

The shoulder beneficially causes a reduction in the circumferential length of the recess. The recess according to the present invention has a circumferential length which is effectively reduced by the provision of the shoulder moving into the recess. The recess therefore beneficially has a further first circumferential length defining an opening and a second reduced circumferential length caused by the provision of the shoulder.

The circumferential length of a first and/or second channel is less than 50% of the inner circumference of the collar, and is preferably less than 30% of the inner circumference of the collar.

The shoulder beneficially extends circumferentially and provides a substantial planar device contact surface.

The ear of the interface arrangement beneficially seats into the recess of the collar. Furthermore, the ear of the interface beneficially seats into the narrowed portion of the recess beyond the shoulder.

The recess is arranged to limit axial insertion of the interface arrangement into the collar. The recess beneficially limits axial insertion of the ear of the interface arrangement into the collar. The interface arrangement beneficially comprises a second ear extending radially outwardly. The second ear is beneficially substantially diametrically opposite the first ear.

Also according to the present invention there is a method of providing a connection to a device comprising providing a device interface arrangement and a collar coaxially and rotatably mounted to the device interface arrangement, rotating the collar between a first configuration enabling releasable engagement with a device, and a second configuration wherein a device is restrained by the collar, the collar having a radial width defined between a radially outer surface and a radially inner surface, wherein the device interface arrangement includes an ear extending radially outwardly, the ear arranged to locate into a recess provided in the radially inwardly surface of the collar, the collar further including a first channel extending circumferentially in the radially inwardly surface, the first channel being in communication with the recess and being arranged such that as the collar rotates relative to the device interface arrangement between the first and second configuration the first channel receives the ear, and further wherein the recess includes a shoulder configured to limit insertion of at least a portion of the device therein, wherein the shoulder is arranged to substantially align at least a portion of the device with a second channel provided in the radially inwardly surface of the collar, and rotation of the collar between the first and second configurations enables the second channel to receive a portion of the device.

These and other objects, features and advantages of the present invention will become more apparent upon reading the following specification in conjunction with the accompanying drawing figures.

### BRIEF DESCRIPTION OF THE DRAWINGS

Embodiments of the present invention will be now described by way of example only with reference to the accompanying drawings in which:

FIGS. 1, 2 and 3 show a prior art connector connecting to a sensing device. FIG. 1 includes the connector body 12, FIG. 2 shows initial contact between the connector and sensing device, and FIG. 3 shows the sensing device in the secured configuration.

FIG. 4 is a schematic perspective view of an interface arrangement according to an exemplary embodiment of the present invention.

FIG. 5 is a schematic perspective view of the interface arrangement and collar wherein the connector is in communication with a sensing device in a first configuration enabling releasable engagement.

FIG. 6 shows the same configuration as FIG. 5 but with the body 12.

FIG. 7 shows the collar in the second configuration wherein the sensor device is restrained by the collar.

### DETAILED DESCRIPTION OF THE PREFERRED EMBODIMENTS

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

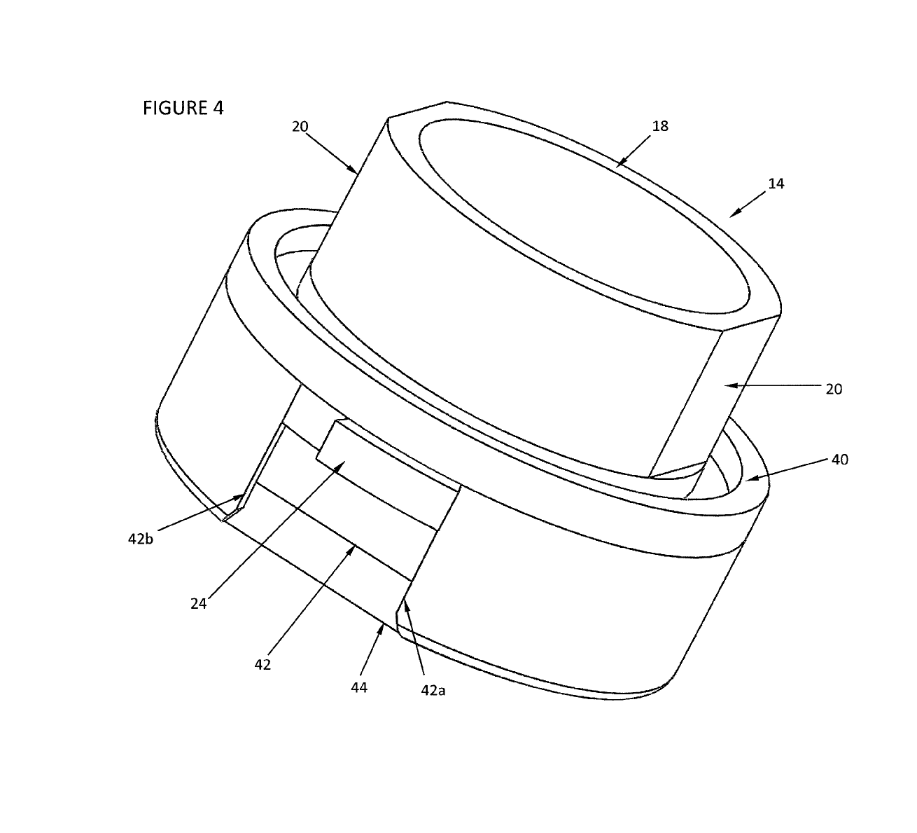

Referring to FIG. 4, the interface arrangement 14 is shown according to a part of an embodiment of the present invention. The rearward section 18 is the same as the prior art arrangement. It is clear in this Fig. that a shoulder 40 is provided which when the connector is assembled abuts against the body 12. This means that the collar 16 is sandwiched between the interface arrangement 14 and in particular the ears 24 when in the first configuration and the body 12. Also as in the prior art arrangement, there is a cutaway portion 42 cut into the peripheral edge extending from a first end 44 of the interface arrangement 14 to the ear 24. This cutaway portion, which beneficially has the corresponding same cutaway portion diametrically opposite, is for receipt of the distal end of the ear 6 of the sensing device. This cutaway 42 is substantial planar in the longitudinal axis and the radially inner surface of the ear of the sensing device abuts this surface. The difference between the interface arrangement 14 as shown in FIG. 4 and the prior art arrangement is the reduction in the circumferential length of the ear 24. In the prior art arrangement this ear 24 extends circumferentially to the same circumferential length as the cutaway 42. However, in the present invention this length has been reduced. As will be shown with respect to the remaining figures, this enables the ear 24 to seat into the recess 22 of a collar 16 without interference from the shoulder 46.

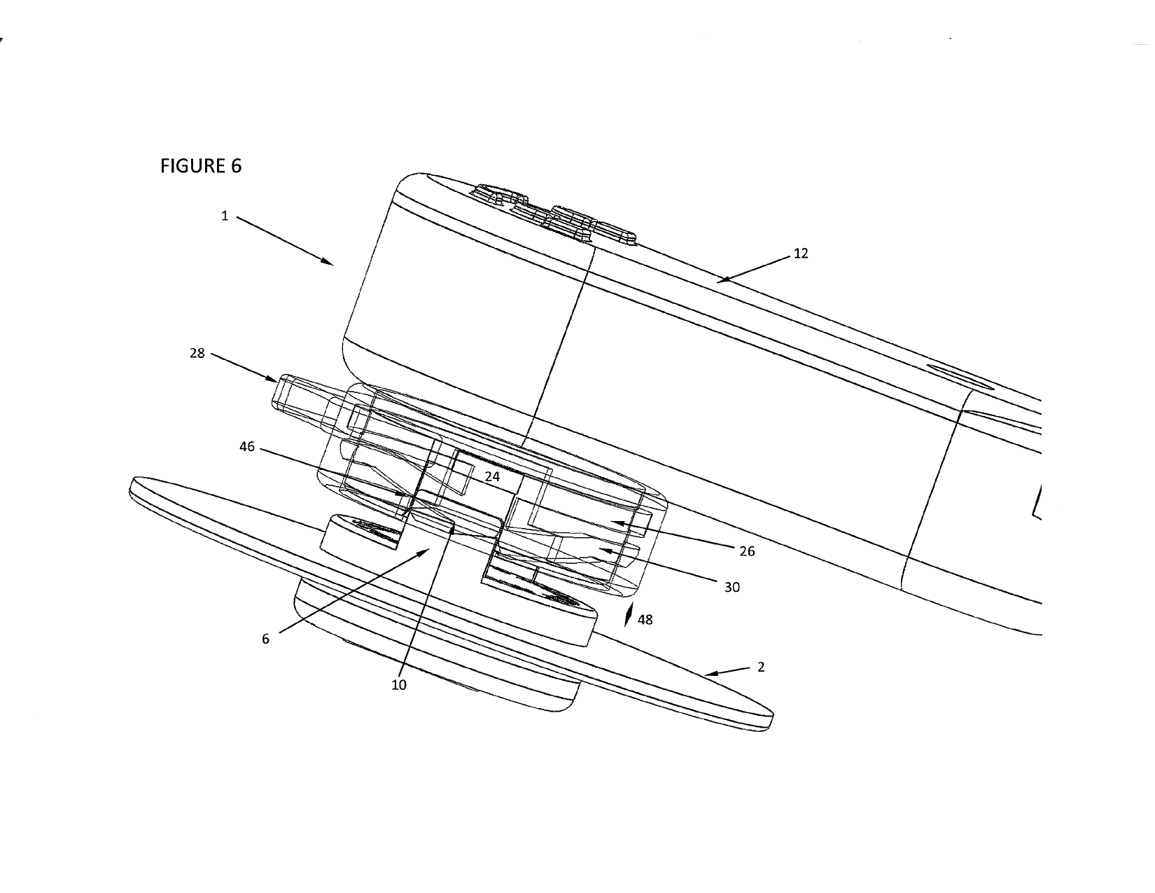

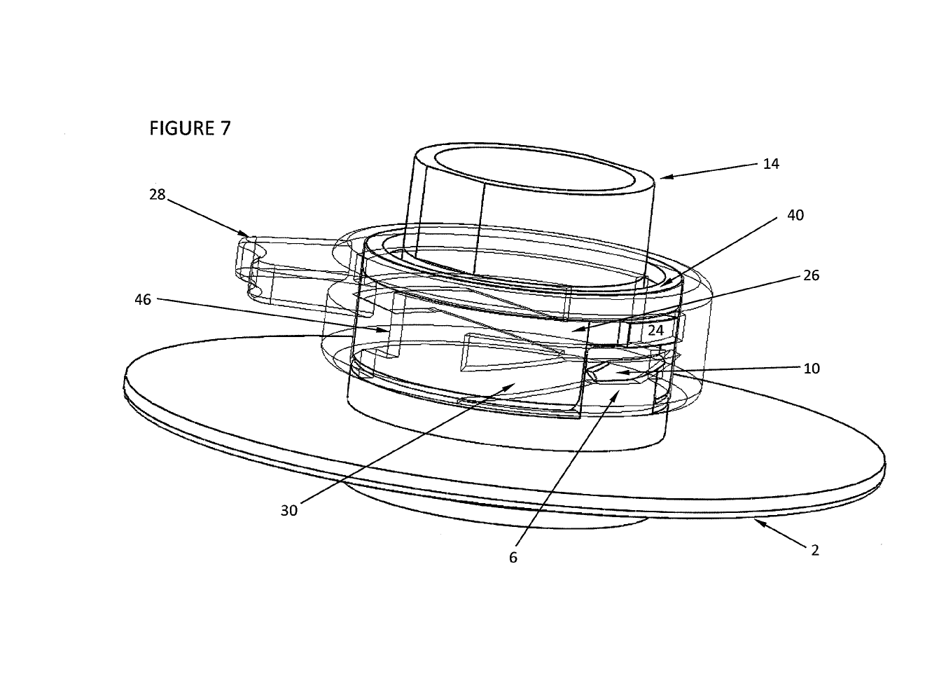

Now referring to FIGS. 6 and 7, where FIG. 6 shows the connector in a first configuration in initial communication with a sensing device, and FIG. 7 shows the connector in a second configuration where the device is restrained by the collar, like components with respect to the prior art arrangements have the same reference numerals. The cutaway 42 defined between circumferential cutaway ends 42a, 42b is shaped to receive the corresponding ears 6 of the sensing device. This cutaway 42 therefore prevents in use the sensing device from rotating as the interface arrangement 14 is secured to the body which is designed not to be moved when the collar is rotated between the first configuration which allows releasable engagement with the sensing device and the second configuration wherein the device is restrained by the collar. Accordingly, the collar 16 is the component that rotates. Both FIGS. 6 and 7, clearly identify the shoulder 46 which enables a significant increase in functionality for an operator.

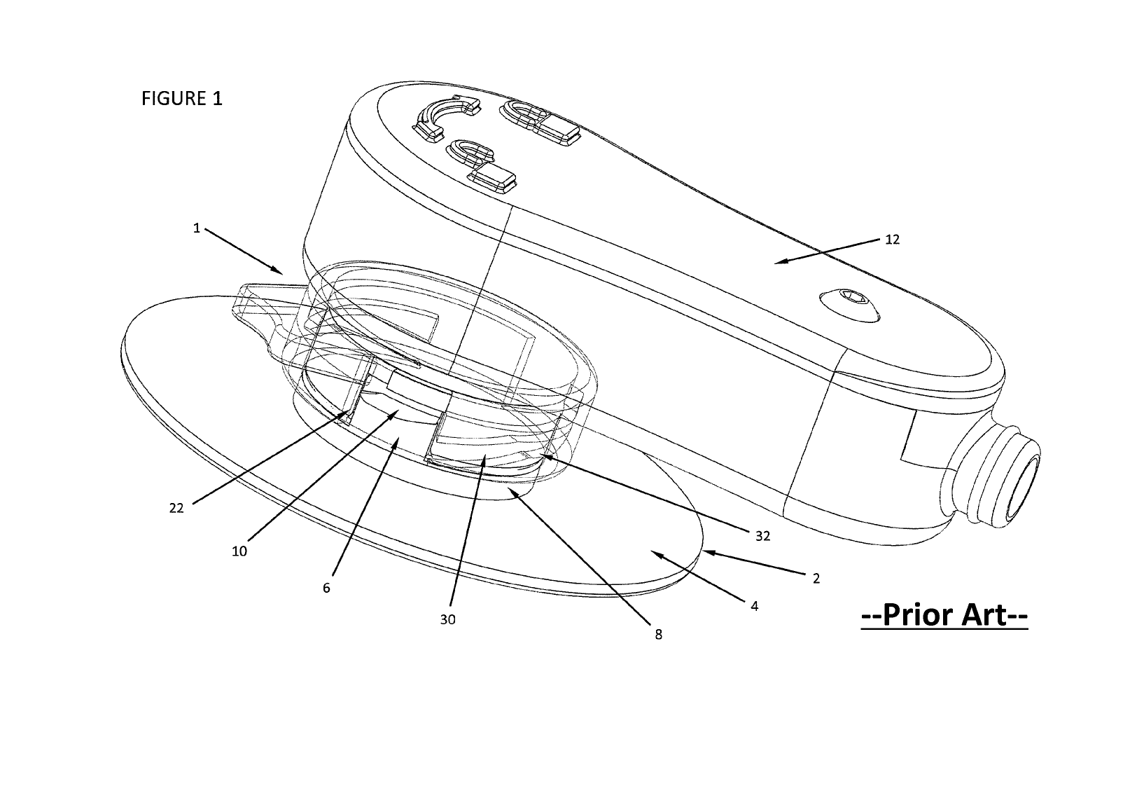

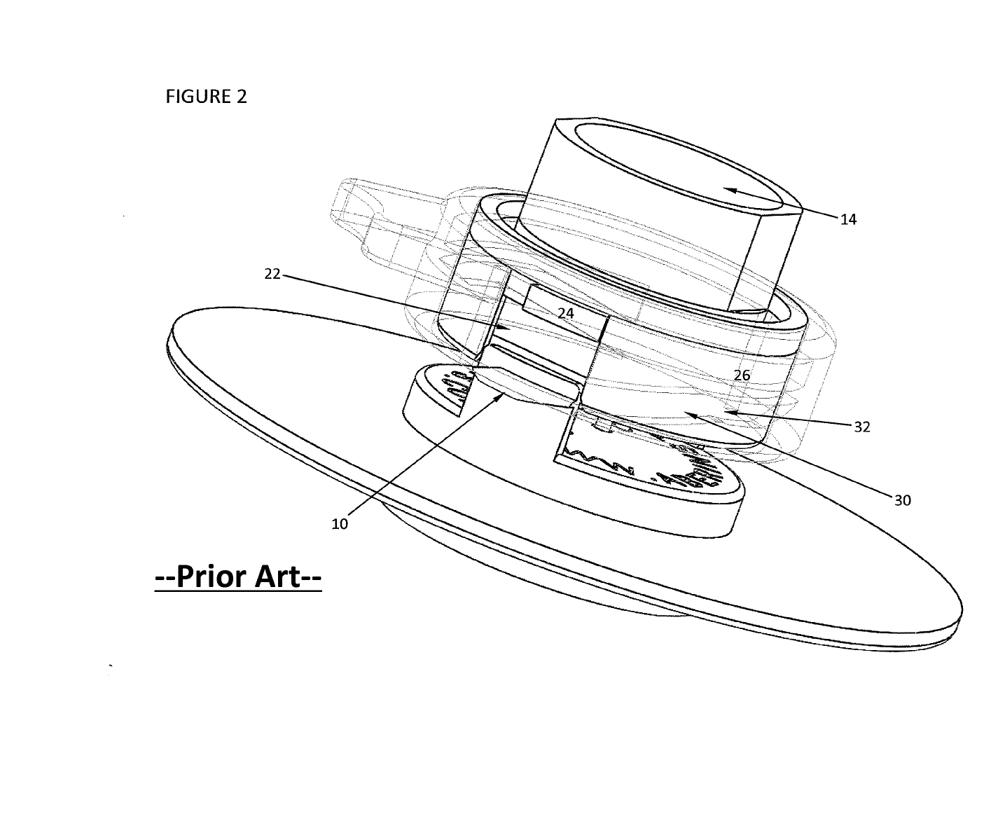

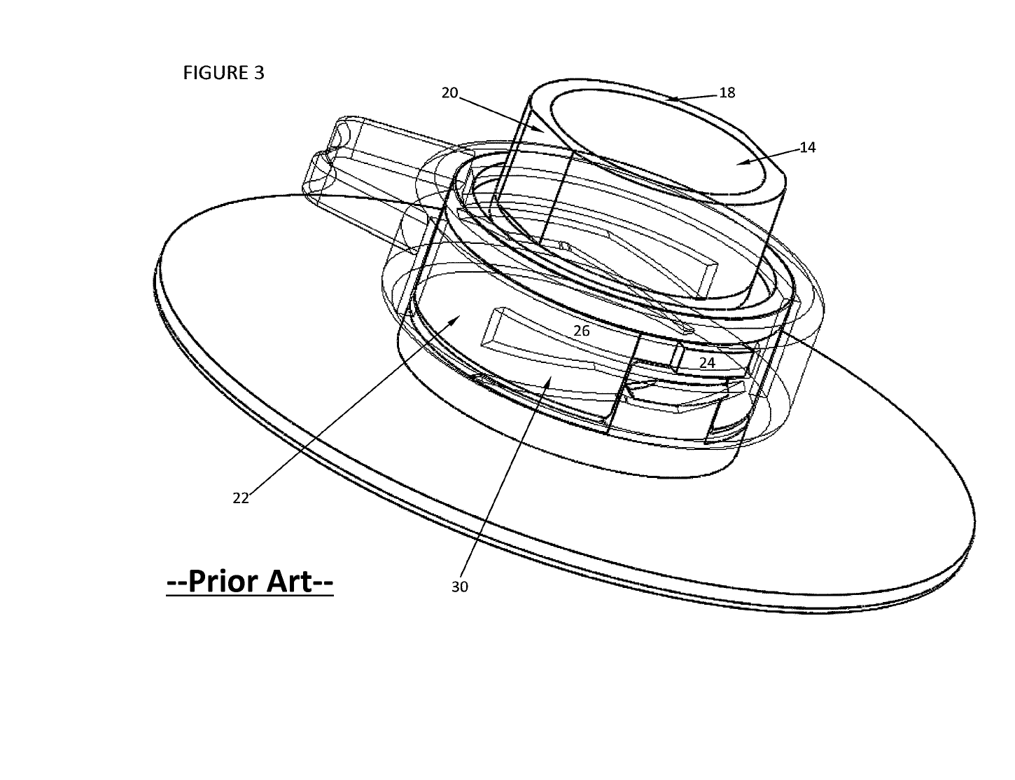

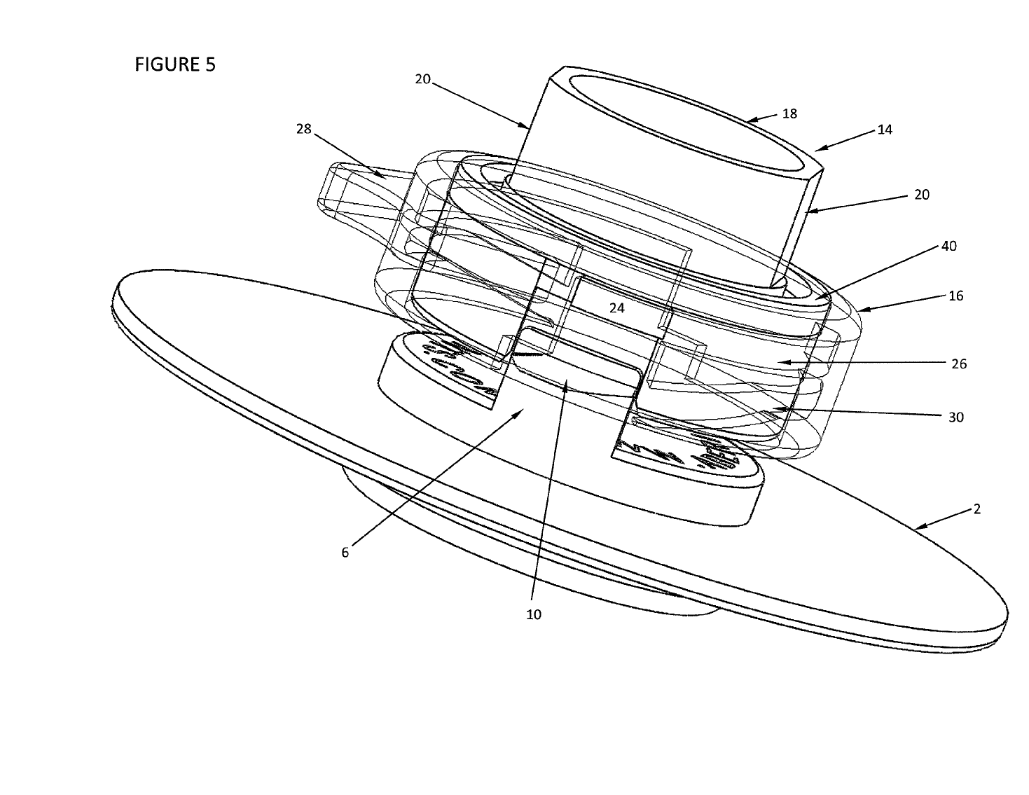

Referring to FIGS. 5, 6 and 7, FIGS. 5 and 6 show the same configuration without and with the body 12. The connector 1 is brought towards the sensing device 2 and the ears 6 of the sensing device 2 are located into the recess 22 of the collar and the corresponding cutaway 42 of the interface arrangement 14. The problem with the prior art arrangement is the insertion of the ear 6 of the sensing device 2 has to be the correct amount in order to align the lateral protrusion 10 of the ear 6 with the second channel 30. The problem is clearly identified in FIG. 1 wherein under normal circumstances and operating conditions it is usual that the ears 6 are inserted too far meaning that the lateral protrusion 10 does not align with the second channel 30. According to the present invention, however, the leading edge or distal end of the ear 6 of the sensing device 2 comes into communication with the shoulder 46. Further insertion is prevented. This is clearly shown in FIG. 6 where it is clear that there is a separation between the interface arrangement 14 and the sensing device 2. This separation is identified by arrow 48. It will be noted, however, that the lateral protrusion 10 of the sensing device 2 is aligned with the second channel 30 meaning that clockwise rotation of the collar 16 draws the second channel 30 around the lateral protrusion 10. As it does so, it effectively draws the rearward portion of the sensing device having the electrodes projecting therefrom into communication with corresponding apertures in the interface arrangement 14 and thus ensures a solid connection between the sensing device 2 and the interface arrangement 14.

It will be appreciated that the reduced circumferential length of the ear 24 of the interface arrangement 14 seats into the reduced circumferential length portion of the recess 22. This ear 24 aligns with the first channel 26 and thus as shown in FIG. 7 where the collar 16 has been rotated the ear 24 is securely positioned in the first channel 26 and the lateral protrusion 10 is securely positioned in the second channel 30. It will be appreciated that the lateral protrusion 10 of the sensing device 2 is shaped along with shape of the second channel 30 to ensure smooth guiding along the second channel 30 to enable secure communication between the interface arrangement 14 and the sensing device 2.

The present invention provides an effective solution to the problems associated with the prior art arrangement that significantly improves usability as it takes away any user requirement for precision in respect of the degree of insertion of the ear 6 into the recess 22 provided in the collar 16 and the corresponding cutaway portion 42 in the interface arrangement 14.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A connector system comprising:
a device interface arrangement; and
a collar coaxially and rotatably mounted to the device interface arrangement;
wherein the collar is arranged to rotate between a first configuration enabling releasable engagement with a device, and a second configuration wherein a device is restrained by the collar, the collar having a radial width defined between a radially outer surface and a radially inner surface;
wherein the device interface arrangement including an ear extending radially outwardly, the ear arranged to locate into a recess provided in the radially inwardly surface of the collar, the collar further including a first channel extending circumferentially in the radially inwardly surface, the first channel being in communication with the recess and being arranged such that as the collar rotates relative to the device interface arrangement between the first and second configuration the first channel receives the ear; and
wherein the recess includes a shoulder configured to limit insertion of at least a portion of the device therein, wherein the shoulder is arranged to substantially align at least a portion of the device with a second channel provided in the radially inwardly surface of the collar, and rotation of the collar between the first and second configurations enables the second channel to receive a portion of the device.

2. The connector system according to claim 1, wherein the shoulder causes a reduction in the circumferential length of the recess.

3. The connector system according to claim 1, wherein the circumferential length of the first and/or second channels is less than 50% of the inner circumference of the collar.

4. The connector system according to claim 1, wherein the circumferential length of the first and/or second channels is less than 30% of the inner circumference of the collar.

5. The connector system according to claim 1, wherein the shoulder extends circumferentially and provides a substantially planar device contact surface.

6. The connector system according to claim 1, wherein the ear of the device interface arrangement seats into the recess of the collar.

7. A connector system according to claim 6, wherein the recess is arranged to limit axial insertion of the device interface arrangement into the collar.

8. The connector system according to claim 1, wherein the device interface arrangement further comprises a second ear extending radially outwardly.

9. A connector system according to claim 8, wherein the second ear is substantially diametrically opposite the first ear.

10. A method of providing a connection to a device comprising:
providing a device interface arrangement and a collar coaxially and rotatably mounted to the device interface arrangement; and
rotating the collar between a first configuration enabling releasable engagement with a device, and a second configuration wherein a device is restrained by the collar, the collar having a radial width defined between a radially outer surface and a radially inner surface;
wherein the device interface arrangement includes an ear extending radially outwardly, the ear arranged to locate into a recess provided in the radially inwardly surface of the collar, the collar further including a first channel extending circumferentially in the radially inwardly surface, the first channel being in communication with the recess and being arranged such that as the collar rotates relative to the device interface arrangement between the first and second configuration the first channel receives the ear; and
wherein the recess includes a shoulder configured to limit insertion of at least a portion of the device therein, wherein the shoulder is arranged to substantially align at least a portion of the device with a second channel provided in the radially inwardly surface of the collar, and rotation of the collar between the first and second configurations enables the second channel to receive a portion of the device.
